(19) United States
(12) Patent Application Publication
(10) Pub. No.: US 2016/0191201 A1
(43) Pub. Date: Jun. 30, 2016

(54) METHOD AND APPARATUS FOR TRANSMITTING CHANNEL QUALITY INDICATOR INFORMATION OF BEAMS IN COMMUNICATION SYSTEM

(71) Applicant: Electronics and Telecommunications Research Institute, Daejeon (KR)

(72) Inventors: Juho PARK, Daejeon (KR); Young Seog SONG, Daejeon (KR); Jun Hwan LEE, Seoul (KR); Eun-Young CHOI, Daejeon (KR); Young Jo KO, Daejeon (KR); Seung Chan BANG, Daejeon (KR)

(21) Appl. No.: 14/982,430

(22) Filed: Dec. 29, 2015

(30) Foreign Application Priority Data
Dec. 29, 2014 (KR) 10-2014-0192655
Dec. 24, 2015 (KR) 10-2015-0185734

(51) Int. Cl. H04L 1/00; H04B 7/06; H04W 24/10; H04B 17/309

(52) U.S. Cl. CPC H04L 1/0026; H04B 17/309; H04B 7/0632; H04B 7/0639; H04W 24/10

(57) ABSTRACT

When a terminal of a mobile communication system using a plurality of beams receives information on a channel quality indicator (CQI) transmission mode from a base station, the terminal measures a CQI of a beam to feed back the CQI information according to the CQI transmission mode, transmits information of the beam to feed back the CQI information according to the CQI transmission mode, and thereafter, feeds back the measured CQI information of the beam to the base station.

### CROSS-REFERENCE TO RELATED APPLICATION

This application claims priority to and the benefit of Korean Patent Application Nos. 10-2014-0192655 and 10-2015-0185734 filed in the Korean Intellectual Property Office on Dec. 29, 2014 and Dec. 24, 2015, the entire contents of which are incorporated herein by reference.

### BACKGROUND OF THE INVENTION

(a) Field of the Invention

The present invention relates to a method and an apparatus for transmitting channel quality indicator information of beams in a communication system, and particularly, to a method and an apparatus for feeding back channel quality indicator (CQI) information for each beam in a terminal of a mobile communication system operating multiple beams.

(b) Description of the Related Art

Since most mobile communication systems including a long term evolution (LTE) system in the related art, and the like use a frequency band of 30 GHz or less, a rich scattering environment can be assumed, in which multiple clusters such as various buildings, and the like are present between a base station and a terminal. In such a rich scattering environment, multiple antennas are installed in the base station, and as a result, it is easy to transmit multiple data to one terminal or to simultaneously support multiple users by using spatial multiplexing through precoding.

On the contrary, attenuation of a signal is heavy in a millimeter wave band and a radio wave reflection characteristic is not also excellent in a building wall, and the like, and as a result, it is not easy to create the rich scattering environment outdoors. Therefore, a method using a directional beam in the terminal positioned in a line-of-sight (LoS) area is established as a core element in a mobile communication system using the frequency in the millimeter wave band. When the directional beam having a beam gain is generated, a beam width decreases, and as a result, simultaneously generating several beams and simultaneously using the simultaneously generated beams in the base station are particularly required for one base station to completely cover a cell and support multiple users positioned at several locations. Further, simultaneously operating several beams in the base station is required to simultaneously transmit several data even to one terminal.

Meanwhile, the terminal generates and announces a CQI to the base station based on a signal-to-noise ratio (SNR) which can be acquired through a serving beam of a serving base station to acquire optimal performance when the base station transmits data to the terminal and the base station decides a code rate and the size of data to be transmitted to the terminal based on the CQI.

In this case, when the base station operates a plurality of beams, the terminal receives signals from several beams and generates the SNR and the CQI for each beam by using a previously known signal such as a pilot signal, or the like included in each beam. Each terminal feeds back to the base station CQIs measured with respect to several beams for optimal terminal scheduling in the base station. The base station can verify in which beam the terminal gets interference at present and generate terminal scheduling showing the optimal performance and transmission data by considering the interference as long as each terminal feeds back the CQI for several beams.

However, when the number of beams which the base station simultaneously uses increases, the CQI information which the terminal needs to feed back to the base station also increases, and as a result, feed-back overhead increases.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method and an apparatus for transmitting channel quality indicator information of beams in a communication system, which can reduce feed-back overhead in a communication system operating multiple beams.

An exemplary embodiment of the present invention provides a method for transmitting channel quality indicator (CQI) information of beams in a terminal of a mobile communication system using a plurality of beams. The method for transmitting channel quality indicator (CQI) information of beams includes: receiving information on a CQI transmission mode from a base station; measuring a CQI of a beam to feed back the CQI information according to the CQI transmission mode; transmitting information of the beam to feed back the CQI information according to the CQI transmission mode; and feeding back the measured CQI information to the base station.

The transmitting of the information of the beam to feed back the CQI information may include setting a bit value corresponding to the beam to feed back the CQI information to a first value in a bitmap, and setting a bit value corresponding to a beam not to feed back the CQI information to a second value different from the first value in the bitmap, and the respective bits of the bitmap may correspond to the plurality of beams, respectively.

The transmitting of the information of the beam to feed back the CQI information may include setting the bit value corresponding to the beam to feed back the CQI information among residual beams other than a serving beam of the terminal to the first value in the bitmap, and setting the bit value corresponding to the beam not to feed back the CQI information to the second value different from the first value in the bitmap, and the respective bits of the bitmap may correspond to the residual beams other than the serving beam among the plurality of beams, respectively.

The transmitting of the information of the beam to feed back the CQI information may include sharing a table storing numbers corresponding to all available combinations of the beams, respectively with respect to the plurality of beams with the base station, and selecting a number corresponding to the beam to feed back the CQI information from the table and transmitting the selected number to the base station.

The transmitting of the information of the beam to feed back the CQI information may include transmitting the information of the beam to feed back the CQI information by using a bitstream constituted by a first field, a second field, and a third field, the second field may represent the number of beams extracted from the third field, the third field may include information of the beam corresponding to the number of beams, and the first field may represent whether the beam included in the third field is the beam to feed back the CQI information.

The information of the beam corresponding to the number of beams may include bit information representing a number corresponding to a combination of the beams to feed back the CQI information.

The transmitting of the information of the beam to feed back the CQI information may include sharing a table storing combinations of beams to receive a feed-back of the CQI information for each mode with the base station when the plurality of respective beams is set as a serving beam, and selecting information of a mode corresponding to the beam to feed back the CQI information among a plurality of modes corresponding to the serving beam from the table and transmitting the selected information to the base station when any one beam among the plurality of beams is decided as the serving beam.

The transmitting of the information of the beam to feed back the CQI information may further include receiving information of a beam to be added to or removed from the base station through signaling.

The measuring of the CQI of the beam to feed back the CQI information may include grouping the plurality of beams into a plurality of groups, and measuring a representative CQI of a group to feed back the CQI information, and the transmitting of the information of the beam to feed back the CQI information may include transmitting information of the group to feed back the CQI information.

Another exemplary embodiment of the present invention provides an apparatus for transmitting channel quality indicator (CQI) information of beams in a terminal of a mobile communication system using a plurality of beams. The apparatus for transmitting channel quality indicator (CQI) information of beams includes: a processor and a transceiver. The processor measures a CQI of a beam to feed back the CQI information according to a CQI transmission mode and creates information of the beam to feed back the CQI information according to the CQI transmission mode. The transceiver receives information on the CQI transmission mode from a base station and transmits the information of the beam to feed back the CQI information to the base station and thereafter, transmits the CQI of the beam to feed back the CQI information to the base station.

The processor may create a bitmap to set a bit value corresponding to the beam to feed back the CQI information to a first value among the plurality of beams and set a bit value corresponding to a beam not to feed back the CQI information to a second value different from the first value, and the respective bits of the bitmap may correspond to the plurality of beams, respectively.

The processor may create a bitmap to set a bit value corresponding to the beam to feed back the CQI information to the first value among residual beams other than a serving beam of the terminal and set a bit value corresponding to a beam not to feed back the CQI information to the second value different from the first value, and the respective bits of the bitmap may correspond to the residual beams other than the serving beam among the plurality of beams, respectively.

The processor may select a number corresponding to the beam to feed back the CQI information from a table storing numbers corresponding to all available combinations of the beams, respectively with respect to the plurality of beams.

The processor may create information of the beam to feed back the CQI information as a bitstream constituted by a first field, a second field, and a third field, the second field may represent the number of beams included in the third field, the third field may include information of the beam corresponding to the number of beams, and the first field may represent whether the beam included in the third field is the beam to feed back the CQI information.

The information of the beam corresponding to the number of beams may include bit information representing a number corresponding to a combination of the beams to feed back the CQI information.

The processor may select information of a mode corresponding to the beam to feed back the CQI information among a plurality of modes corresponding to the serving beam when any one beam among the plurality of beams is decided as the serving beam by using a table storing combinations of beams to feed back the CQI information for each mode when the plurality of respective beams is set as the serving beam.

The processor may measure a representative CQI of a group to feed back the CQI information when the plurality of beams is grouped into a plurality of groups, and the information of the beam to feed back the CQI information may include information of the group to feed back the CQI information.

### BRIEF DESCRIPTION OF THE DRAWINGS

FIG. 1 is a diagram illustrating one example of a mobile communication system operating multiple beams according to an exemplary embodiment of the present invention.

Each of FIGS. 2 to 7 is a diagram for describing a CQI transmission mode according to first to sixth exemplary embodiments of the present invention.

FIG. 8 is a flowchart illustrating a method for transmitting CQI information for each beam in a terminal according to an exemplary embodiment of the present invention.

FIG. 9 is a flowchart illustrating a method for receiving CQI information for each beam in a base station according to an exemplary embodiment of the present invention.

FIG. 10 is a diagram illustrating an apparatus for transmitting CQI information of beams according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification and all claims, unless explicitly described to the contrary, the word “comprise” and variations such as “comprises” or “comprising”, will be understood to imply the inclusion of stated elements but not the exclusion of any other elements.

Throughout the specification, a terminal may be designated as a mobile terminal (MT), a mobile station (MS), an advanced mobile station (AMS), a high reliability mobile station (HR-MS), a subscriber station (SS), a portable subscriber station (PSS), an access terminal (AT), user equipment (UE), and the like and include all or some functions of the MT, the MS, the AMS, the HR-MS, the SS, the PSS, the AT, the UE, and the like.

Further, a base station (BS) may be designated as an advanced base station (ABS), a high reliability base station (HR-BS), a node B, an evolved node B (eNodeB), an access point (AP), a radio access station (RAS), a base transceiver station (BTS), a mobile multihop relay (MMR)-BS, a relay station (RS) serving as the base station, a relay node (RN) serving as the base station, an advanced relay station (ARS) serving as the base station, a high reliability relay station (HR-RS) serving as the base station, small-sized base stations [femto BS, a home node B (HNB), a home eNodeB (HeNB), a pico BS, a metro BS, a micro BS, and the like], and the like and include all or some functions of the ABS, the NodeB, the eNodeB, the AP, the RAS, the BTS, the MMR-BS, the RS, the RN, the ARS, the HR-RS, the small-sized base stations, and the like.

Hereinafter, a method and an apparatus for transmitting channel quality indicator (CQI) information of beams in a communication system according to exemplary embodiments of the present invention will be described in detail with reference to the accompanying drawings.

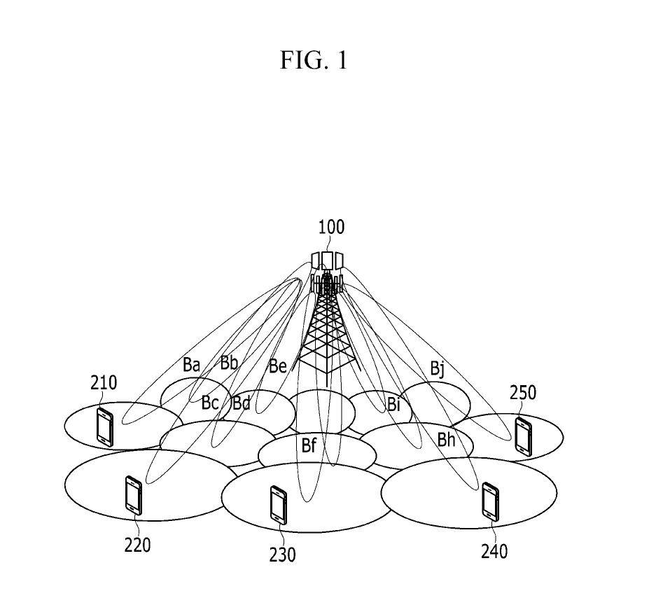

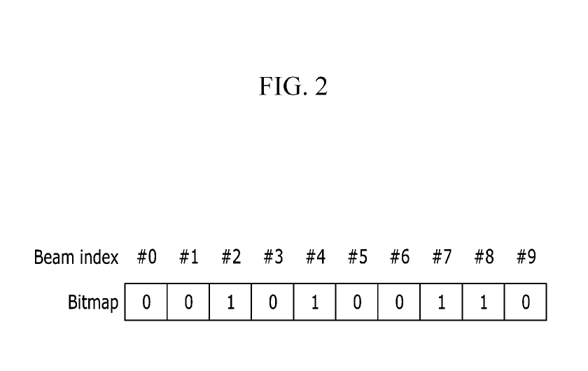

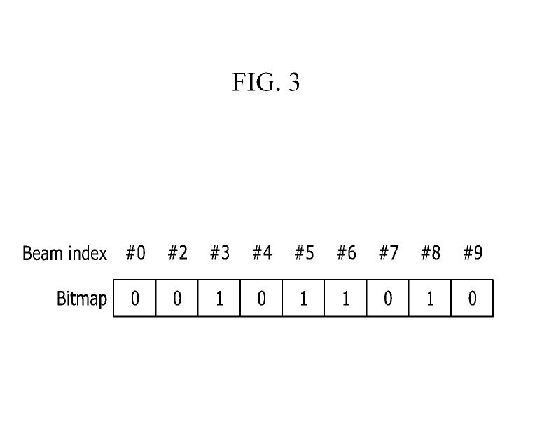

FIG. 1 is a diagram illustrating one example of a mobile communication system operating multiple beams according to an exemplary embodiment of the present invention.

Referring to FIG. 1, the mobile communication system includes a base station 100 and at least one terminal 210, 220, 230, 240, and 250.

The base station 100 and the terminals 210, 220, 230, 240, and 250 may perform communication by using a millimeter wave band of 30 to 300 GHz. The millimeter wave band is wider than a band of 30 GHz or less used in a mobile communication network in the related art and it is easy to allocate consecutive radio resources to increase a capacity of a communication system. However, since the millimeter wave band is strong in linearity and radio wave loss, the base station 100 and the terminals 210, 220, 230, 240, and 250 use beamforming technology in order to over the linearity and the radio wave loss.

The base station 100 generates multiple beams B1 to Bj by using the beamforming technology in the milimeterwave band and simultaneously transmits data and signals to the multiple terminals 210, 220, 230, 240, and 250 through the multiple beams B1 to Bj. Each of the beams B1 to Bj may be identified by a beam index. For example, the base station 100 may simultaneously transmit the data and the signals to the terminals 210, 220, 230, 240, and 250 through the beams Ba, Bc, Bf, Bh, and Bj. The beamforming technology may be classified into fixed and adaptive beamforming technologies. Fixed beams generated by the fixed beamforming technology have predetermined beam direction and sizes, respectively. When the base station 100 operates the fixed beams, the base station 100 may generate the multiple beams B1 to Bj so as to cover the entirety of a cell. The base station 100 may generate the multiple beams B1 to Bj so as to overlap with adjacent beams in order to prevent a coverage hole. Meanwhile, directions and sizes of adaptive beams generated by the adaptive beamforming technology adaptively vary according to a change of a channel and locations of the base station 100 or the terminals 210, 220, 230, 240, and 250.

The terminals 210, 220, 230, 240, and 250 transmit/receive the signals by using a directional beam or omnidirectional beam. The terminals 210, 220, 230, 240, and 250 may select a directional beam which most coincides with a direction in which the signal transmitted by the base station 100 reaches among various directional beams which may be used and communicate with the base station 100 by using the selected directional beam.

As described above, in the communication system that performs the communication by using the beamforming technology, the base station 100 periodically receives the channel quality indicator (CQI) information for each beam from each of multiple terminals, selects terminals to which the base station 100 will transmit the CQI information, for example, the terminals 210, 220, 230, 240, and 250 based on the CQI information for each beam of each terminal, and selects one or more optimal beams for communication with the respective selected terminals 210, 220, 230, 240, and 250. Further, the base station 100 decides a code rate and the size of data to be transmitted to each terminal based on the CQI information for each beam of each selected terminal 210, 220, 230, 240, or 250.

The terminals 210, 220, 230, 240, and 250 periodically or aperiodically measure a channel quality, for example, a signal-to-noise ratio (SNR) by using a reference signal transmitted for each beam from the base station 100 and generates the CQI for each beam based on the measured the channel quality information and feeds back the generated CQI to the base station 100. The reference signal transmitted for each beam may be a unique pilot signal for each beam.

The terminals 210, 220, 230, 240, and 250 may feed back to the base station 100 the CQIs for all beams B1 to Bj operated by the base station 100 and feed back only CQIs for some beams to the base station 100. When the terminals 210, 220, 230, 240, and 250 feed back only the CQIs for some beams to the base station 100, as long as the terminals 210, 220, 230, 240, and 250 announces information about some beams to feed back the CQI information to the base station 100, the base station 100 may know to which beam CQI information to be transmitted afterward corresponds.

In the exemplary embodiment of the present invention, a CQI transmission mode for the terminals 210, 220, 230, 240, and 250 to announce information on the beams to feed back the CQI information to the base station 100 will be described in detail. For easy description, the CQI transmission mode will be described based on the terminal 210.

FIG. 2 is a block diagram for describing a CQI transmission mode according to a first exemplary embodiment of the present invention.

In the CQI transmission mode illustrated in FIG. 2, a bitmap is used. The bitmap has the same bit length as the number of beams operated by the base station 100. Respective bits of the bitmap correspond to the respective beams operated by the base station 100.

The terminal 210 sets a bit value corresponding to the beam to feed back the CQI information to 1 and transmits to the base station 100 the bitmap in which sets a bit value corresponding to a beam not to feed back the CQI information to 0 to announce information on some beams to feed back the CQI information to the base station.

For example, it is assumed that the number of beams operated by the base station 100 is 10 and most significant bit to least significant bit of the bitmap correspond to 10 beams corresponding to beam indexes #0 to #9, respectively. In this case, when the beams to feed back the CQI information are 4 beams corresponding to beam indexes #2, #4, #7, and #8, the terminal 210 sets bits corresponding to #2, #4, #7, and #8 to 1 and transmits set 1 to the base station 100 as illustrated in FIG. 2.

The base station 100 may know that the CQI information received from the terminal afterwards is the CQI information corresponding to #2, #4, #7, and #8 based on the bitmap received from the terminal 210.

FIG. 3 is a block diagram for describing a CQI transmission mode according to a second exemplary embodiment of the present invention.

In the CQI transmission mode illustrated in FIG. 3, a bitmap having a shorter than length in FIG. 2 is used.

The CQI transmission mode illustrated in FIG. 3 may be used when the terminal 210 previously promises the base station 100 to continuously transmit CQI information of a specific beam and there is a beam to transmit CQI information among residual beams. The bitmap has the same bit length as the number of residual beams other than the specific beam previously promised with the base station 100 among all beams operated by the base station 100 and each bit of the bitmap corresponds to residual beams other than the specific beam previously promised with the base station 100 among all beams operated by the base station 100.

For example, it is assumed that the base station 100 operates 10 beams corresponding to beam indexes #0 to #9 and the terminal previously promises the base station 100 to continuously transmit CQI information of a serving beam. In this case, 9 beams other than the serving beam among 10 beams may correspond to each bit of the bitmap. In this case, the beam indexes of 9 beams other than the serving beam are arranged in an ascending order to correspond to most significant bit to least significant bit of the bitmap, respectively.

When the serving beam is the beam corresponding to #1 and the beams to feed back the CQI information are 4 beams corresponding to #3, #5, #6, and #8, the terminal 210 sets bits corresponding to #3, #5, #6, and #8 to 1 in the bitmap and transmits set 1 to the base station 100 as illustrated in FIG. 3.

The base station 100 may know that the CQI information received from the terminal afterwards is #1 corresponding to the serving beam and the CQI information corresponding to #3, #5, #6, and #8 based on the bitmap received from the terminal 210.

Information on the beam to transmit the CQI information to the base station 100 may be announced by a scheme that announces any one number except for a method using the bitmap.

FIG. 4 is a block diagram for describing a CQI transmission mode according to a third exemplary embodiment of the present invention.

In the CQI transmission mode illustrated in FIG. 4, the information on the beam to transmit the CQI information to the base station 100 is announced by using any one number.

The base station 100 determines a specific number with respect to combinations of all beams available with respect to all beams operated by the base station 100 and stores numbers corresponding to the combinations of the beams in a table 400. In addition, the base station 100 shares information of the table 400 with the terminal 210.

The terminal 210 selects the number corresponding to the beam from the table 400 and transmits the selected number to announce the information on the beam to feed back the CQI information to the base station 100. For example, the numbers may correspond to all combinations of the beams with respect to all beams operated by the base station 100 as illustrated in FIG. 4. As illustrated in FIG. 4, 0 represents that the beam to feed back the CQI information is #0 and 1 represents that the beam to feed back the CQI information is #1. 231 represents that the beam to feed back the CQI information is #1, #2, and #4 and 232 represents that the beam to feed back the CQI information is #1, #4, and #6. The terminal 210 selects one of the numbers illustrated in FIG. 4 to transmit the selected one number to the base station 100 according to the beam to feed back the CQI information.

The base station 100 may know in which beams CQI information will be transmitted from the terminal 210 based on the numbers transmitted from the terminal 210.

However, when the number of beams operated by the base station 100 increases, the size of the table 400 required for the base station 100 and the terminal 210 to exchange beam information may significantly increase and when the terminal 210 feeds back the beam information to the base station 100, the waste of the resource may be severe. Accordingly, a method that may transfer the information on the beam to transmit the CQI information by an efficient scheme is required and when the information on the beam to transmit the CQI information is transmitted by a scheme described below, the terminal 210 may announce the beam information to the base station 100 with a small number of bits.

FIG. 5 is a block diagram for describing a CQI transmission mode according to a fourth exemplary embodiment of the present invention.

In the CQI transmission mode illustrated in FIG. 5, the information on the beam to transmit the CQI information is announced to the base station 100 by using a bitstream.

The bitstream according to the CQI transmission mode illustrated in FIG. 5 is constituted by 3 fields.

A first field announces whether beams extracted through a second field and a third field are the beam to feed back the CQI information or a beam not to feed back the CQI information. The first field may be constituted by 1 bit and the first field may be constituted by for example, most significant bit (MSB) of the bitstream. When the first field represents the beam to feed back the CQI information, the beam indexes extracted through the second and third fields represent the beam to feed back the CQI information. Further, when the first field represents the beam not to feed back the CQI information, the beam indexes extracted through the second and third fields represent the beam not to feed back the CQI information. In this case, CQI information on beams corresponding to residual beam indexes other than the beam indexes extracted through the second and third fields may be transmitted from the terminal 210 to the base station 100.

The second field represents the number of beams extracted in the third field.

The third field announces a beam corresponding to the number of beam decided according to a value of the second field. In this case, a number corresponding to a combination of the beams to feed back the CQI information may be expressed by bits in the third field. When the number of the beams to feed back the CQI information is M, r which is a combination of M beams may be created as shown in Equation 1.

$$r = {\sum }_{i = 0}^{M - 1} 〈 \begin{matrix}N - {s}_{i} \\ M - i\end{matrix} 〉 \qquad ( Equation 1 )$$

Where, {sᵢ}ᵢ₌₀^{M-1} represents an index of the beam to transmit the CQI, 1≦Sᵢ≦N, Sᵢ≦Sᵢ₊₁, and N represents the number of all beams. Further,

$$〈 \begin{matrix}x \\ y\end{matrix} 〉 = \{ \begin{matrix}( \begin{matrix}x \\ y\end{matrix} ) & x \geq y \\ 0 & x < y\end{matrix}$$

represents an extended binomial coefficient.

r which is a unique value is created through Equation 1 and

$$r ∈ \{ 0 , … , ( \begin{matrix}N \\ M\end{matrix} ) - 1 \} .$$

In this case, since

$$r \leq ( \begin{matrix}N \\ M\end{matrix} ) - 1 ,$$

the length of the third field may vary depending on the value of the second field and a maximum length of the third field may be

$$⌈ {log}_{2} [ ( \begin{matrix}N \\ ⌈ N / 2 ⌉\end{matrix} ) - 1 ] ⌉ .$$

FIG. 6 is a block diagram illustrating a CQI transmission mode according to a fifth exemplary embodiment of the present invention.

In the CQI transmission mode illustrated in FIG. 6, the terminal 210 predetermines the beam to feed back the CQI information and announces the information on the beam to transmit the CQI information to the base station 100 by using the information.

The base station 100 predetermines the combination of the beams receiving the fed-back CQI information for each mode when any beam is set as the serving beam in the terminal 210 and stores a combination of beams for each mode for each serving beam in a table 600. In addition, the base station 100 shares information of the table 600 with the terminal 210 through a random access process with the terminal 210. Therefore, when a specific bema is decided as the serving beam in the terminal 210, information of a mode corresponding to the combination of the beams to feed back the CQI information among a plurality of modes depending on the serving beam is transmitted to the base station 100 to announce the information on the beam to transmit the CQI information to the base station 100.

For example, the base station 100 determines the combination of the beams receiving the fed-back CQI information for each of modes Mode 0, Mode 1, . . . , Mode n when respective beams are set as the serving beam with respect to beams having beam indexes of #0 to #N−1, respectively as illustrated in FIG. 6 and a combination of beams receiving the fed-back CQI information for each of the modes Mode 0, Mode 1, . . . , Mode n for each serving beam may be stored in the table 600. When the beam having the beam index of #1 is decided as the serving beam, in the case where the beams to feed back the CQI information are 4 beams corresponding to #0, #3, and #4 including the serving beam of #1, the terminal 210 transmits information of a mode (Mode 1) to the base station 100 to announce the beam to receive the fed-back CQI information to the base station 100.

The base station 100 may know that the CQI information of 4 beams corresponding to #1, #0, #3, and #4 is transmitted from the terminal 210 based on the information (Mode 1) transmitted from the terminal 210.

In this case, the number of beams receiving the CQI information may also be adjusted. For example, it is assumed that when the beam having the beam index of #1 is decided as the serving beam of the terminal 210, the base station 100 receives the feed-back of the CQI information of 4 beams corresponding to #1, #0, #3, and #4 from the terminal 210. The base station 100 may request addition of the beam to receive the feed-back of the CQI information through signaling and further, decrease the number of beams to receive the feed-back of the CQI information. For example, when the base station 100 additionally requests a CQI feed-back of another beam corresponding to the serving beam #1 of the terminal 210 through the signaling, the terminal 210 changes the mode to a mode (Mode 2) to feed back the CQI information on #0, #1, #3, #4, and #5. On the contrary, when the base station 100 requests the decrease in the number of beams to receive the feed-back of the CQI information through the signaling, the terminal 210 changes the mode (Mode 1) to a mode (Mode 0) to feed back CQIs corresponding to the beams #1, #1, and #2 to the base station 100. In this case, the terminal 210 transmits information of the changed mode to the base station 100 to announce the beam to receive the feed-back of the CQI information to the base station 100.

Such a scheme is useful particularly when the base station 100 uses the fixed beam. Since the beam transmitted from the base station 100 is fixedly created, since it may be previously known that a signal of a beam around a specific beam is strong, the base station 100 may determine the combination of the beams to receive the feed-back of the CQI information for each mode when any beam is decided as the serving beam in the terminal 210 by using the information.

FIG. 7 is a diagram for describing a CQI transmission mode according to a sixth exemplary embodiment of the present invention.

In the CQI transmission mode illustrated in FIG. 7, grouping beams is used. All beams operated by the base station 100 are divided into a plurality of groups and each group has a group index. In this case, the base station 100 and the terminal 200 may previously determine and know information indicating which beam belongs to each group or the terminal 200 may divide all beams into the plurality of groups by performing grouping and announce the information indicating which beam belongs to each group to the base station 100.

The terminal 210 decides a representative CQI of each group and feeds back representative CQI information of each group to the base station 100. The representative CQI of each group may be a value representing CQIs of beams in each group. As the representative CQI, an average value of the CQIs of the beams in the group may be used or a maximum value or a minimum value among the CQIs of the beams in the group may be used. In this case, the terminal 210 transmits information of a group that will feed back the CQI information to the base station 100 to announce information on a beam to transmit the CQI information to the base station 100.

For example, 10 beams having beam indexes of #0 to #9, respectively are grouped to create 4 groups G0, G1, G2, and G3 as illustrated in FIG. 7. The terminal 210 measures CQIs CQI_0, CQI_1, CQI_2, and CQI_3 of the respective groups G0, G1, G2, and G3. The terminal 210 transmits information of the groups G0, G1, G2, and G3 that will transmit the CQI information to the base station 100 to announce the information on the beam to transmit the CQI information to the base station 100.

As described above, when the terminal 210 transmits the representative CQI information of each group, the amount of the CQI information which the terminal 210 will feed back to the base station 100 may be significantly reduced.

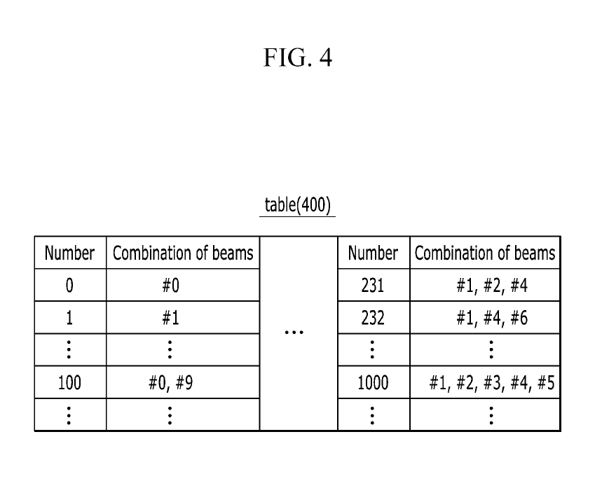

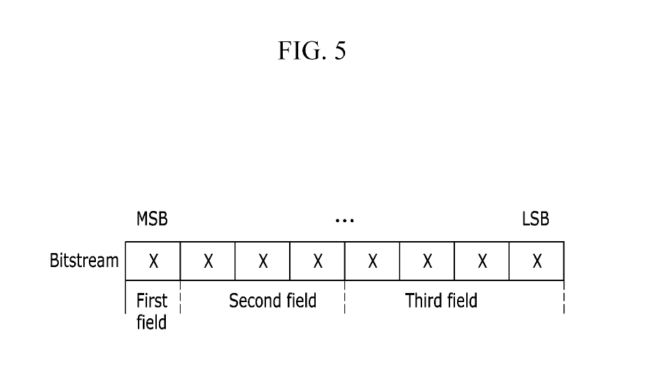

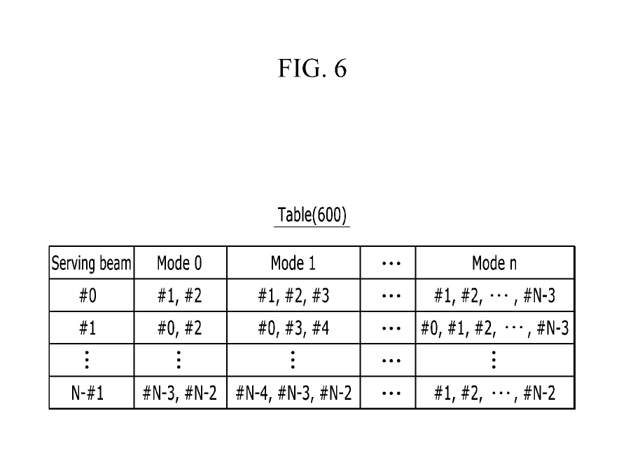

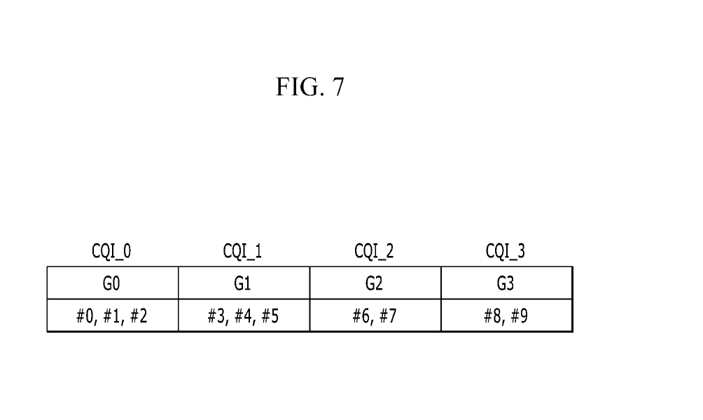

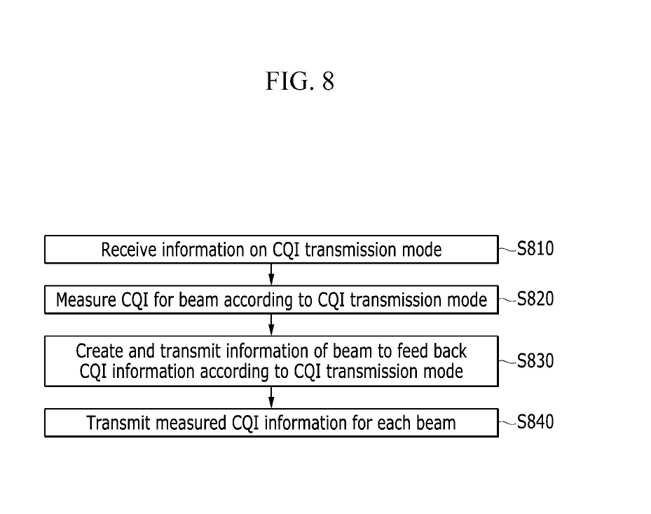

FIG. 8 is a flowchart illustrating a method for transmitting CQI information for each beam in a terminal according to an exemplary embodiment of the present invention.

Referring to FIG. 8, the terminal 210 receives information on a CQI transmission mode from the base station 100. The CQI transmission mode may represent one of CQI transmission modes described in FIGS. 2 to 7. The information on the CQI transmission mode may be periodically transmitted or transmitted when the CQI transmission mode is intended to be changed.

The terminal 210 measures a CQI for each beam according to the CQI transmission mode (S820).

The terminal 210 creates the information of the beam to feed back the CQI information according to the CQI transmission mode and transmits the generated information to the base station 100 (S830). For example, when the CQI transmission mode represents the CQI transmission mode illustrated in FIG. 2, the terminal 210 creates a bitmap to correspond to the beam to feed back the CQI information and transmits the bitmap to the base station 100.

Next, the terminal 210 transmits the measured CQI information for each beam to the base station 100 (S840).

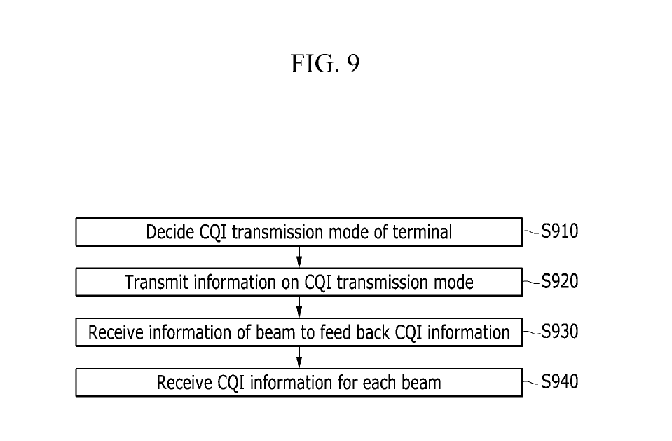

FIG. 9 is a flowchart illustrating a method for receiving CQI information for each beam in a base station according to an exemplary embodiment of the present invention.

Referring to FIG. 9, the base station 100 decides the CQI transmission mode of the terminal 210 (S910). The base station 100 may verify whether the CQI transmission mode used in the related art needs to be changed and decide the CQI transmission mode to be changed when changing the CQI transmission mode is required.

The base station 100 transmits information on the decided CQI transmission mode to the terminal 210 (S920).

The base station 100 receives the information of the beam to feed back the CQI information from the terminal 210 (S930). The information of the beam to feed back the CQI information is created according to the CQI transmission mode by the terminal 210. For example, when the CQI transmission mode represents the CQI transmission mode illustrated in FIG. 6, the terminal 210 may select a mode corresponding to the beam to feed back the CQI information among a plurality of modes according to the serving beam and transmit information of the selected mode to the base station 100.

Next, the base station 100 receives the CQI information for each beam from the terminal 210 (S940). The CQI information for each beam may also be measured according to the CQI transmission mode by the terminal 210. For example, when the CQI transmission mode represents the CQI transmission mode illustrated in FIG. 7, the terminal 210 may measure a CQI of the beam group.

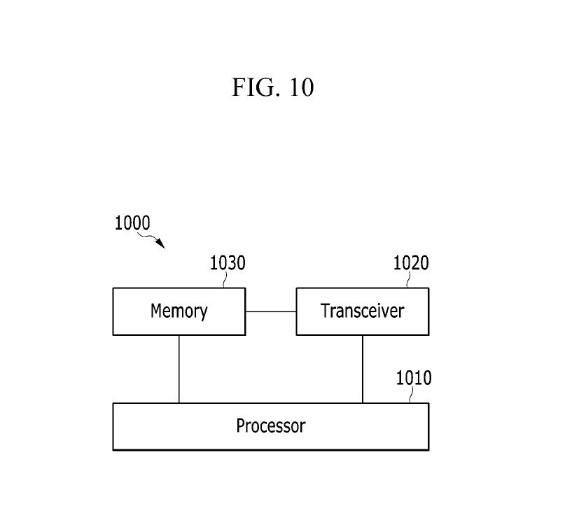

FIG. 10 is a diagram illustrating an apparatus for transmitting CQI information of beams according to an exemplary embodiment of the present invention.

Referring to FIG. 10 the apparatus 1000 for transmitting CQI information of beams includes a processor 1010, a transceiver 1020, and a memory 1030. The apparatus 1000 for transmitting CQI information of beams may be implemented in terminals 210 to 250.

The processor 1010 measures CQI information for each beam according to a CQI transmission mode received from the base station 100 and creates information of a beam to transmit the CQI information. The processor 1010 may create the information of the beam to transmit the CQI information like the methods described in FIGS. 2 to 7 according to the CQI transmission mode.

The transceiver 1020 transmits/receives data or signals to/from the base station 100. In particular, the transceiver 1020 may receive the information on the CQI transmission mode from the base station 100 and transmit to the base station 100 the information of the beam to feed back the CQI information and the CQI information for each beam.

The memory 1030 stores instructions for transmitting the CQI information for each beam in the processor 1010 or loads the instructions from a storage device (not illustrated) and temporarily stores the instructions and the processor 1010 executes the instructions stored in or loaded from the memory 1030.

The processor 1010 and the memory 1030 may be connected with each other through a bus (not illustrated) and an input/output interface (not illustrated) may also be connected to the bus. In this case, the transceiver 1020 may be connected to the input/output interface and peripheral devices including an input device, a display, a speaker, a storage device, and the like may be connected to the input/output interface.

According to exemplary embodiments of the present invention, feed-back overhead for feeding back a CQI for each beam in a communication system operating multiple beams can be minimized.

The exemplary embodiments of the present invention are not embodied only by the apparatus and/or the method described above and the above-mentioned exemplary embodiments may be embodied by a program performing functions, which correspond to the configuration of the exemplary embodiments of the present invention, or a recording medium on which the program is recorded. These embodiments can be easily devised from the description of the above-mentioned exemplary embodiments by those skilled in the art to which the present invention pertains.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for transmitting channel quality indicator (CQI) information of beams in a terminal of a mobile communication system using a plurality of beams, the method comprising:
receiving information on a CQI transmission mode from a base station;
measuring a CQI of a beam to feed back the CQI information according to the CQI transmission mode;
transmitting information of the beam to feed back the CQI information according to the CQI transmission mode; and
feeding back the measured CQI information to the base station.

2. The method of claim 1, wherein:
the transmitting of the information of the beam to feed back the CQI information includes
setting a bit value corresponding to the beam to feed back the CQI information to a first value in a bitmap, and
setting a bit value corresponding to a beam not to feed back the CQI information to a second value different from the first value in the bitmap, and
the respective bits of the bitmap corresponds to the plurality of beams, respectively.

3. The method of claim 1, wherein:
the transmitting of the information of the beam to feed back the CQI information includes
setting a bit value corresponding to the beam to feed back the CQI information among residual beams other than a serving beam of the terminal to a first value in a bitmap, and
setting a bit value corresponding to the beam not to feed back the CQI information to a second value different from the first value in the bitmap, and
the respective bits of the bitmap correspond to the residual beams other than the serving beam among the plurality of beams, respectively.

4. The method of claim 1, wherein:
the transmitting of the information of the beam to feed back the CQI information includes
sharing a table storing numbers corresponding to all available combinations of the beams, respectively with respect to the plurality of beams with the base station, and
selecting a number corresponding to the beam to feed back the CQI information from the table and transmitting the selected number to the base station.

5. The method of claim 1, wherein:
the transmitting of the information of the beam to feed back the CQI information includes transmitting the information of the beam to feed back the CQI information by using a bitstream constituted by a first field, a second field, and a third field,
the second field represents the number of beams extracted from the third field,
the third field includes information of the beam corresponding to the number of beams, and
the first field represents whether the beam included in the third field is the beam to feed back the CQI information.

6. The method of claim 5, wherein:
the information of the beam corresponding to the number of beams includes bit information representing a number corresponding to a combination of the beams to feed back the CQI information.

7. The method of claim 1, wherein:
the transmitting of the information of the beam to feed back the CQI information includes
sharing a table storing combinations of beams to receive a feed-back of the CQI information for each mode with the base station when the plurality of respective beams is set as a serving beam, and
selecting information of a mode corresponding to the beam to feed back the CQI information among a plurality of modes corresponding to the serving beam from the table and transmitting the selected information to the base station when any one beam among the plurality of beams is decided as the serving beam.

8. The method of claim 7, wherein:
the transmitting of the information of the beam to feed back the CQI information further includes receiving information of a beam to be added to or removed from the base station through signaling.

9. The method of claim 1, wherein:
the measuring of the CQI of the beam to feed back the CQI information includes
grouping the plurality of beams into a plurality of groups, and
measuring a representative CQI of a group to feed back the CQI information, and
the transmitting of the information of the beam to feed back the CQI information includes transmitting information of the group to feed back the CQI information.

10. An apparatus for transmitting channel quality indicator (CQI) information of beams in a terminal of a mobile communication system using a plurality of beams, the apparatus comprising:
a processor measuring a CQI of a beam to feed back the CQI information according to a CQI transmission mode and creating information of the beam to feed back the CQI information according to the CQI transmission mode; and
a transceiver receiving information on the CQI transmission mode from a base station and transmitting the information of the beam to feed back the CQI information to the base station and thereafter, transmitting the CQI of the beam to feed back the CQI information to the base station.

11. The apparatus of claim 10, wherein:
the processor creates a bitmap to set a bit value corresponding to the beam to feed back the CQI information to a first value among the plurality of beams and set a bit value corresponding to a beam not to feed back the CQI information to a second value different from the first value, and
the respective bits of the bitmap corresponds to the plurality of beams, respectively.

12. The apparatus of claim 10, wherein:
the processor creates a bitmap to set a bit value corresponding to the beam to feed back the CQI information to a first value among residual beams other than a serving beam of the terminal and set a bit value corresponding to a beam not to feed back the CQI information to a second value different from the first value, and
the respective bits of the bitmap correspond to the residual beams other than the serving beam among the plurality of beams, respectively.

13. The apparatus of claim 10, wherein:
the processor selects a number corresponding to the beam to feed back the CQI information from a table storing numbers corresponding to all available combinations of the beams, respectively with respect to the plurality of beams.

14. The apparatus of claim 10, wherein:
the processor creates information of the beam to feed back the CQI information as a bitstream constituted by a first field, a second field, and a third field,
the second field represents the number of beams included in the third field,
the third field includes information of the beam corresponding to the number of beams, and
the first field represents whether the beam included in the third field is the beam to feed back the CQI information.

15. The apparatus of claim 14, wherein:
the information of the beam corresponding to the number of beams includes bit information representing a number corresponding to a combination of the beams to feed back the CQI information.

16. The apparatus of claim 10, wherein:
the processor selects information of a mode corresponding to the beam to feed back the CQI information among a plurality of modes corresponding to the serving beam when any one beam among the plurality of beams is decided as the serving beam by using a table storing combinations of beams to feed back the CQI information for each mode when the plurality of respective beams is set as the serving beam.

17. The apparatus of claim 10, wherein:
the processor measures a representative CQI of a group to feed back the CQI information when the plurality of beams is grouped into a plurality of groups, and
the information of the beam to feed back the CQI information includes information of the group to feed back the CQI information.
